(19) United States
(12) Patent Application Publication
(10) Pub. No.: US 2026/0355792 A1
(43) Pub. Date: Nov. 12, 2026

(54) EXHAUST STRUCTURE AND SUBSTRATE TREATMENT APPARATUS

(71) Applicant: SEMES CO., LTD., Cheonan-si (KR)

(72) Inventors: Ki Sang EUM, Cheonan-si (KR); Chi Hyeon KIM, Cheonan-si (KR); Dae Kwan YUN, Cheonan-si (KR)

(21) Appl. No.: 19/635,856

(22) Filed: Apr. 1, 2026

(30) Foreign Application Priority Data
May 8, 2025 (KR) 10-2025-0059472

(51) Int. Cl. B08B 9/045; B08B 9/043

(52) U.S. Cl. CPC B08B 9/045; B08B 9/0436

(57) ABSTRACT

Provided are an exhaust structure and a substrate treatment apparatus. An exhaust structure for a substrate treatment apparatus according to an example embodiment includes: an individual exhaust duct connected to a processing chamber configured to treat a substrate; a damper configured to adjust an exhaust pressure of the individual exhaust duct; and a cleaner installed in the damper, wherein the cleaner includes: a brush installed in the damper, and configured to clean at least one of the inside of the individual exhaust duct and the damper; and a driving motor configured to rotate the brush.

### CROSS-REFERENCE TO RELATED APPLICATION(S)

This application claims benefit of priority to Korean Patent Application No. 10-2025-0059472 filed on May 8, 2025 in the Korean Intellectual Property Office, the disclosure of which is incorporated herein by reference in its entirety.

### BACKGROUND

### 1. FIELD

The present disclosure relates to an exhaust structure and a substrate treatment apparatus for preventing a change in exhaust pressure inside a processing chamber.

### 2. DESCRIPTION OF RELATED ART

In order to manufacture a semiconductor device, various processes such as cleaning, deposition, photolithography, etching, and ion implantation are performed. These processes are carried out in a processing chamber having a substrate treatment space therein.

In general, the substrate treatment space of the processing chamber is required to maintain a constant process atmosphere. For this reason, the process atmosphere is exhausted by an exhaust structure so as to maintain a preset pressure. The exhaust structure not only maintains the process atmosphere at a constant pressure, but also exhausts process byproducts generated during substrate treatment.

For example, in a process of liquid-treating the substrate with a treatment liquid or in a process of baking the substrate, process byproducts such as fumes are generated, and such byproducts are exhausted by the exhaust structure.

The exhaust structure includes an individual exhaust duct, an individual duct connected to a liquid treatment chamber for liquid-treating the substrate or a bake chamber for heating the substrate, and a main exhaust duct, a main duct connected to each individual exhaust duct. The individual exhaust duct connects the processing chamber and the main exhaust duct to each other, and the main exhaust duct is depressurized by a depressurizing member. Process byproducts generated inside the processing chamber are exhausted sequentially through the individual exhaust duct and the main exhaust duct.

At this time, fumes generated during the liquid-treating process or the baking process are accumulated on an inner surface of the individual exhaust duct, which acts as a factor changing the exhaust pressure inside the processing chamber. According to experimental data, the exhaust pressure in the processing chamber significantly affects a removal rate of process byproducts in the processing chamber and a processing rate for each region of the substrate.

### SUMMARY

An aspect of the present disclosure is to provide an exhaust structure and a substrate treatment apparatus removing fumes, which cause a change in exhaust pressure inside a processing chamber.

According to an aspect of the present disclosure, an exhaust structure for a substrate treatment apparatus includes: an individual exhaust duct connected to a processing chamber configured to treat a substrate; a damper configured to adjust an exhaust pressure of the individual exhaust duct; and a cleaner installed in the damper, wherein the cleaner includes: a brush installed in the damper, and configured to clean at least one of the inside of the individual exhaust duct and the damper; and a driving motor configured to rotate the brush.

The brush may be installed through the damper.

The damper may include: a pressure regulating bar configured to reciprocate from the outside of the individual exhaust duct toward an outlet of the individual exhaust duct, the pressure regulating bar having a pressure regulating plate, and the brush may include: a rotation shaft rotatably disposed through the pressure regulating bar and connected to the driving motor; and a plurality of brush bristles formed at an end portion of the rotation shaft.

The rotation shaft may extend to the outside of the pressure regulating plate, and the plurality of brush bristles may be connected to the end portion of the rotation shaft and arranged in a radial direction.

The plurality of brush bristles may be formed to have a length greater than a radius of the individual exhaust duct so as to touch an inner surface of the individual exhaust duct.

Some of the plurality of brush bristles may be disposed in contact with the pressure regulating plate so as to touch the pressure regulating plate.

According to another aspect of the present disclosure, an exhaust structure for a substrate treatment apparatus includes: an individual exhaust duct connected to a processing chamber configured to treat a substrate; a main exhaust duct connected to an outlet of the individual exhaust duct; a damper installed in the main exhaust duct, and configured to adjust an exhaust pressure of the individual exhaust duct; and a cleaner installed in the damper, wherein the cleaner includes: a brush installed in the damper, and configured to clean at least one of an inner surface of the outlet of the individual exhaust duct and a distal end portion of the damper; and a driving motor configured to rotate the brush, and the brush is installed through the damper, and has a plurality of brush bristles in contact with at least one of the inner surface of the outlet of the individual exhaust duct and the distal end portion of the damper.

According to another aspect of the present disclosure, a substrate treatment apparatus includes: a processing chamber having a substrate treatment space for treating a substrate; a substrate support disposed inside the processing chamber, configured to support the substrate, and having a heater installed therein; and an exhaust structure configured to exhaust gases including fumes inside the processing chamber, wherein the exhaust structure includes: an individual exhaust duct connected to the processing chamber; a main exhaust duct connected to an outlet of the individual exhaust duct; a damper installed in the main exhaust duct, and configured to adjust an exhaust pressure of the individual exhaust duct; and a cleaner installed in the damper, the cleaner includes: a brush installed in the damper, and configured to clean at least one of an inner surface of the outlet of the individual exhaust duct and a distal end portion of the damper; and a driving motor configured to rotate the brush, and the brush is installed through the damper, and has a plurality of brush bristles in contact with at least one of the inner surface of the outlet of the individual exhaust duct and the distal end portion of the damper.

The cleaner, the exhaust structure, and the substrate treatment apparatus according to an example embodiment of the present disclosure are advantageous in that the brush rotated by the driving motor is formed in the damper of the individual exhaust duct to remove fumes from at least one of the inside of the individual exhaust duct and the damper, thereby preventing a change in exhaust pressure inside the processing chamber.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view illustrating a substrate treatment apparatus according to an example embodiment of the present disclosure;

FIG. 2 is a view of the substrate treatment apparatus of FIG. 1 as viewed from above;

FIG. 3 is a view of the substrate treatment apparatus of FIG. 2 as viewed in an A–A direction;

FIG. 4 is a view of the substrate treatment apparatus of FIG. 2 as viewed in a B–B direction;

FIG. 5 is a view illustrating a processing chamber of the substrate treatment apparatus of FIG. 1;

FIG. 6 is a view illustrating an exhaust structure connected to the processing chamber of FIG. 5;

FIG. 7 is a view illustrating the exhaust structure of FIG. 6; and

FIGS. 8 and 9 are views illustrating a damper and a brush of the exhaust structure of FIG. 7.

### DETAILED DESCRIPTION

Hereinafter, preferred example embodiments will be described in detail with reference to the attached drawings so that those having ordinary knowledge in the art to which the present disclosure pertains can easily carry out the present disclosure. However, in describing the preferred example embodiments of the present disclosure in detail, detailed descriptions of relevant known functions or configurations will be omitted if deemed unnecessarily obscuring the gist of the present disclosure. In addition, parts performing similar functions and actions will be denoted by the same reference numerals throughout the drawings. In addition, in the present specification, the terms ‘on,’ ‘upper,’ ‘top,’ ‘under,’ ‘lower,’ ‘bottom,’ and the like are used based on the drawings, and may vary depending on directions in which components are actually disposed.

In addition, throughout the specification, when one part is described as being ‘connected’ to another part, this includes not only cases in which the parts are ‘directly connected’ but also cases in which the parts are ‘indirectly connected’ with another component interposed therebetween. Furthermore, throughout the specification, the term ‘include’ when used to describe a certain component means that other components may be further included, rather than excluding other components, unless specifically stated otherwise.

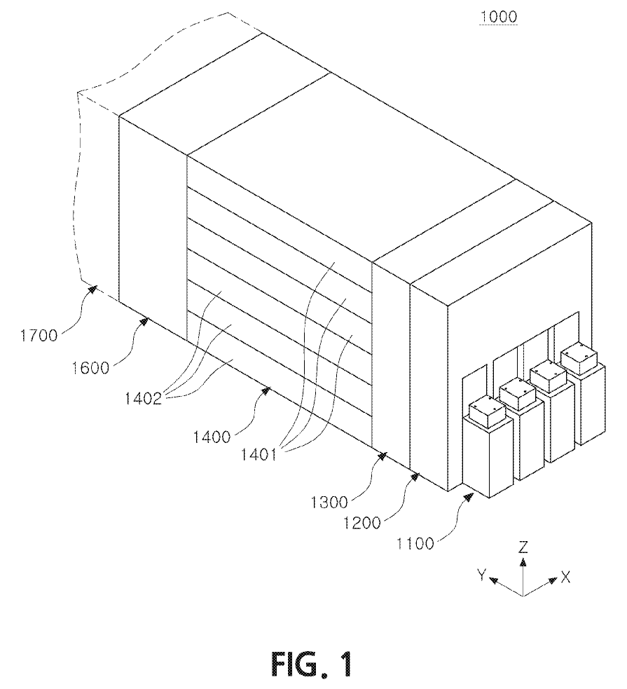

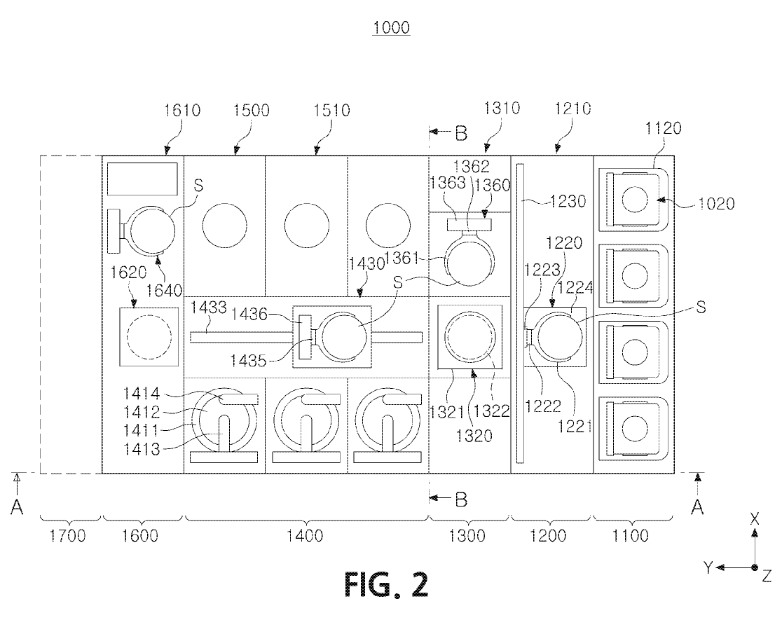

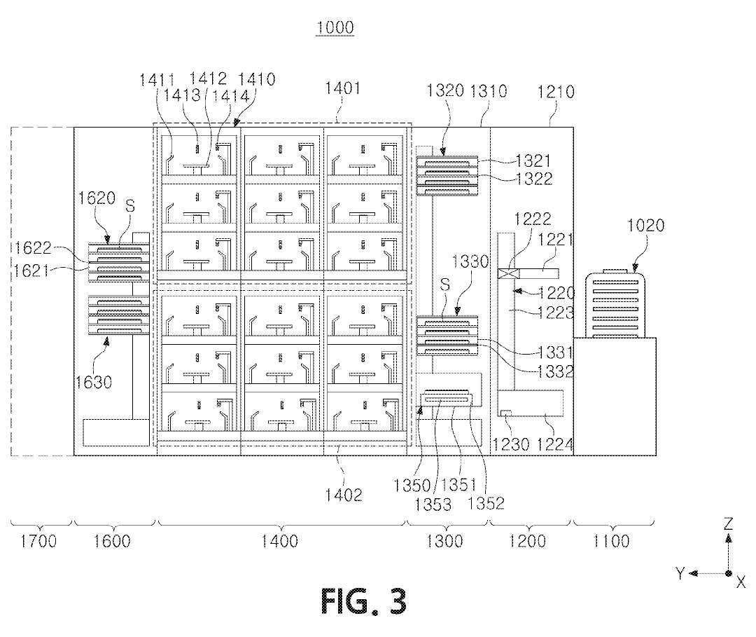

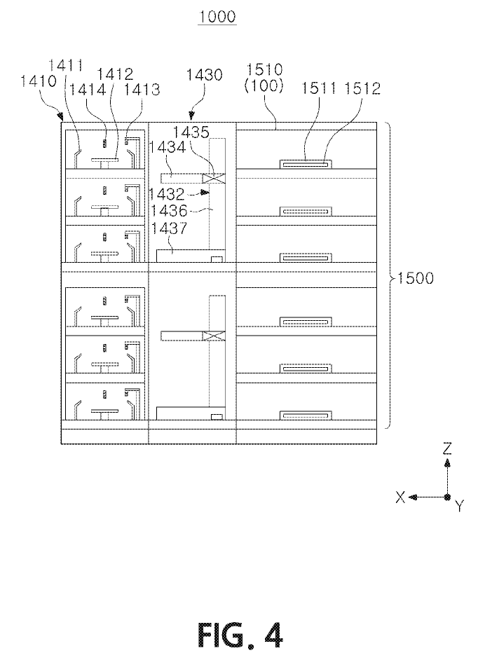

FIGS. 1-4 schematically illustrate a substrate treatment apparatus according to an example embodiment of the present disclosure, in which FIG. 1 is a perspective view illustrating the substrate treatment apparatus, FIG. 2 is a view of the substrate treatment apparatus of FIG. 1 as viewed from above, FIG. 3 is a view of the substrate treatment apparatus of FIG. 2 as viewed in an A–A direction, and FIG. 4 is a view of the substrate treatment apparatus of FIG. 2 as viewed in a B–B direction.

Referring to FIGS. 1-4, the substrate treatment apparatus 1000 includes a load port 1100, an index module 1200, a buffer module 1300, an application and development module 1400, and a purge module 1800. The load port 1100, the index module 1200, the buffer module 1300, the application and development module 1400, and an interface module 1600 are arranged sequentially in a line in one direction.

Hereinafter, the direction in which the load port 1100, the index module 1200, the buffer module 1300, the application and development module 1400, and the interface module 1600 are arranged will be referred to as first direction Y, the direction perpendicular to the first direction Y when viewed from above will be referred to as second direction X, and the direction perpendicular to both the first direction Y and the second direction X will be referred to as third direction Z.

A substrate S is moved while being accommodated in a cassette. The cassette has a structure that can be sealed from the outside. For example, a front open unified pod (FOUP) having a door on the front side may be used as the cassette.

Hereinafter, the load port 1100, the index module 1200, the buffer module 1300, the application and development module 1400, and the interface module 1600 will be described in detail.

The load port 1100 has a mounting table 1120 on which the cassette accommodating the substrate S is placed. A plurality of mounting tables 1120 are provided, and the mounting tables 1120 are arranged in a line along the second direction X. In an example illustrated FIG. 2, four mounting tables 1120 are provided, but the number of mounting tables 1120 may be changed.

The index module 1200 transfers the substrate S between the cassette placed on the mounting table 1120 of the load port 1100 and the buffer module 1300. The index module 1200 includes a frame 1210, an index robot 1220, and a guide rail 1230. The frame 1210 is generally formed in a hollow rectangular parallelepiped shape, and is disposed between the load port 1100 and the buffer module 1300. The frame 1210 of the index module 1200 may be provided at a lower height than a frame 1310 of the buffer module 1300. The index robot 1220 and the guide rail 1230 are disposed inside the frame 1210. The index robot 1220 is provided such that a hand 1221 that directly handles the substrate S can be rotated to move in the first direction Y, the second direction X, and the third direction Z. The index robot 1220 includes a hand 1221, an arm 1222, a support 1223, and a pedestal 1224. The hand 1221 is fixedly installed on the arm 1222. The arm 1222 is provided in a flexible structure and a rotatable structure. The support 1223 is disposed such that its longitudinal direction extends along the third direction Z. The arm 1222 is coupled to the support 1223 so as to be movable along the support 1223. The support 1223 is fixedly coupled to the pedestal 1224. The guide rail 1230 is provided such that its longitudinal direction extends along the second direction X. The pedestal 1224 is coupled to the guide rail 1230 so as to be movable linearly along the guide rail 1230. In addition, although not illustrated, a door opener for opening and closing the door of the cassette is further provided in the frame 1210.

The buffer module 1300 includes a frame 1310, a first buffer 1320, a second buffer 1330, a cooling chamber 1350, and a first buffer robot 1360. The frame 1310 is provided in a hollow rectangular parallelepiped shape, and is disposed between the index module 1200 and the application and development module 1400. The first buffer 1320, the second buffer 1330, the cooling chamber 1350, and the first buffer robot 1360 are located inside the frame 1310. The cooling chamber 1350, the second buffer 1330, and the first buffer 1320 are arranged sequentially from the bottom along the third direction Z. The first buffer 1320 is positioned at a height corresponding to an application module 1401 of the application and development module 1400, and the second buffer 1330 and the cooling chamber 1350 are provided at a height corresponding to a development module 1402 of the application and development module 1400. The first buffer robot 1360 is positioned at a certain distance from the second buffer 1330, the cooling chamber 1350, and the first buffer 1320 in the second direction X. Each of the first buffer 1320 and the second buffer 1330 temporarily store a plurality of substrates S. The second buffer 1330 has a housing 1331 and a plurality of supports 1332. The supports 1332 are disposed inside the housing 1331, and are provided to be spaced apart from each other in the third direction Z. One substrate S is placed on each support 1332. The housing 1331 has openings in directions in which the index robot 1220 and the first buffer robot 1360 are provided, so that the index robot 1220 and the first buffer robot 1360 can load or unload the substrates S into or from the supports 1332 inside the housing 1331. The first buffer 1320 has a structure that is generally similar to that of the second buffer 1330. However, a housing 1321 of the first buffer 1320 has openings in directions in which the first buffer robot 1360 and an application unit robot 1432 located in the application module 1401 are provided. The number of supports 1322 provided in the first buffer 1320 and the number of supports 1332 provided in the second buffer 1330 may be equal or different. In an example, the number of supports 1332 provided in the second buffer 1330 may be larger than the number of supports 1322 provided in the first buffer 1320.

The first buffer robot 1360 transfers the substrate S between the first buffer 1320 and the second buffer 1330 as illustrated in FIG. 2. The first buffer robot 1360 includes a hand 1361, an arm 1362, and a support 1363. The hand 1361 is fixedly installed on the arm 1362. The arm 1362 is provided in a flexible structure, so that the hand 1361 is movable along the second direction X. The arm 1362 is coupled to the support 1363 so as to be movable linearly in the third direction Z along the support 1363. The support 1363 has a length extending from a position corresponding to the second buffer 1330 to a position corresponding to the first buffer 1320. The support 1363 may be provided to extend further in an upward or downward direction. The first buffer robot 1360 may be provided such that the hand 1361 is driven only in two axes along the second direction X and the third direction Z.

The cooling chamber 1350 cools each substrate S, as illustrated in FIG. 3. The cooling chamber 1350 includes a housing 1351 and a cooling plate 1352. The cooling plate 1352 has an upper surface on which the substrate S is placed and a cooling means 1353 for cooling the substrate S. The cooling means 1353 may employ various cooling schemes, such as cooling using a coolant and cooling using a thermoelectric element. In addition, a lift pin assembly for positioning the substrate S on the cooling plate 1352 may be provided in the cooling chamber 1350. The housing 1351 has openings in directions in which the index robot 1220 and a developing unit robot provided in the development module 1402 are provided, so that the index robot 1220 and the developing unit robot can load or unload the substrates S onto or from the cooling plate 1352. In addition, doors for opening and closing the above-described openings may be provided in the cooling chamber 1350.

The application module 1401 includes a process of applying a photosensitive liquid such as a photoresist onto the substrate S, and a heat treatment process such as heating and cooling the substrate S before and after the resist application process. The application module 1401 has an application chamber 1410, a bake chamber unit 1500, and a conveyance chamber 1430. The application chamber 1410, the conveyance chamber 1430, and the bake chamber unit 1500 are arranged sequentially along the second direction X. That is, with respect to the conveyance chamber 1430, the application chamber 1410 is provided on one side of the conveyance chamber 1430, and the bake chamber unit 1500 is provided on the other side of the conveyance chamber 1430.

A plurality of application chambers 1410 are provided in each of the first direction Y and the third direction Z. The bake chamber unit 1500 includes a plurality of bake chambers 1510, and the plurality of bake chambers 1510 are provided in each of the first direction Y and the third direction Z. The conveyance chamber 1430 is positioned parallel to the first buffer 1320 of the first buffer module 1300 in the first direction Y. An application unit robot 1432 and a guide rail 1433 are located inside the conveyance chamber 1430. The conveyance chamber 1430 has a generally rectangular shape. The application unit robot 1432 transfers the substrate S between the bake chamber 1510, the application chamber 1410, and the first buffer 1320 of the first buffer module 1300.

The guide rail 1433 is disposed such that its longitudinal direction is parallel to the first direction Y. The guide rail 1433 guides the application unit robot 1432 to move linearly in the first direction Y. As illustrated in FIG. 4, the application unit robot 1432 includes a hand 1434, an arm 1435, a support 1436, and a pedestal 1437. The hand 1434 is fixedly installed on the arm 1435. The arm 1435 is provided in a flexible structure, so that the hand 1434 is movable in the horizontal direction. The support 1436 is provided such that its longitudinal direction extends along the third direction Z. The arm 1435 is coupled to the support 1436 so as to be movable linearly along the support 1436 in the third direction Z. The support 1436 is fixedly coupled to the pedestal 1437, and the pedestal 1437 is coupled to the guide rail 1433 so as to be movable along the guide rail 1433.

The application chambers 1410 may all have the same structure, but the type of chemical solutions used in the respective application chambers 1410 may be different. As the chemical solution, a chemical solution for forming a photoresist film or an anti-reflection film may be used.

The application chamber 1410 applies a chemical solution onto the substrate S. The application chamber 1410 has a cup 1411, a substrate support 1412, and a nozzle 1413. The cup 1411 is open on an upper side thereof. The substrate support 1412 is positioned inside the cup 1411 and supports the substrate S. The substrate support 1412 is rotatably provided. The nozzle 1413 supplies the chemical solution onto the substrate S placed on the substrate support 1412. The chemical solution is applied onto the substrate S by a spin coating method. In addition, a nozzle 1414 for supplying a cleaning solution such as deionized water (DIW) and a back rinse nozzle (not illustrated) for cleaning the lower surface of the substrate S may be further provided in the application chamber 1410 to clean the surface of the substrate S onto which the chemical solution is applied.

A substrate support 1511 and a heater 1512 built in the substrate support 1511 are installed in a substrate treatment space inside the bake chamber 1510, and the application unit robot 1432 heat-treats the substrate S when the substrate S is placed on the substrate support 1511. For example, the bake chamber 1510 heats the substrate S to a predetermined temperature before applying the photoresist to remove organic substances or moisture on the surface of the substrate S, dries the photoresist through a soft bake process after applying the photoresist on the substrate S, and performs a cooling process to cool the substrate S after each heating (baking) process.

The interface module 1600 connects the application and development module 1400 to an external exposure device 1700. The interface module 1600 includes an interface frame 1610, a first interface buffer 1620, a second interface buffer 1630, and a conveyance robot 1640. The conveyance robot 1640 conveys, to the exposure device 1700, the substrate conveyed to the first and second interface buffers 1620 and 1630 after having passed through the application and development module 1400. The first interface buffer 1620 includes a housing 1621 and a support 1622, and the conveyance robot 1640 and the application unit robot 1432 load and unload the substrate S onto and from the support 1622.

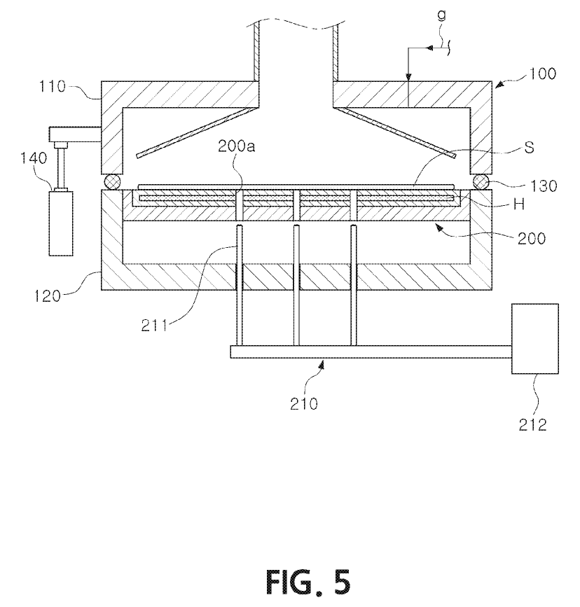

FIG. 5 is a view illustrating a processing chamber of the substrate treatment apparatus of FIG. 1.

Referring to the drawing, a substrate treatment apparatus 1000 according to the present disclosure may include a processing chamber 100 in which a substrate support 200 is disposed.

A substrate treatment space for heat-treating the substrate S is formed in the processing chamber 100. The processing chamber 100 may include an upper body 110 and a lower body 120 so that the substrate treatment space is formed. A sealing member 130 may be installed in one of the upper body 110 and the lower body 120, and a body lifting member 140 may be installed in the upper body 110. A gas supply line g may be connected to an upper portion of the upper body 110 so that gases are supplied to the substrate S. The gases may be supplied into the substrate treatment space while heating the substrate S to improve the adhesion of the photoresist (photosensitive liquid) onto the substrate. The processing chamber 100 may be the above-described bake chamber 1510 (in FIG. 2), and it is not needless to say that the use of the processing chamber 100 is not limited to that described above, and the processing chamber 100 may be used in any process for heating the substrate.

The substrate support 200 is disposed in the substrate treatment space, and stably supports the substrate S. A heater H for heating the substrate may be installed in the substrate support 200.

Then, the substrate S supported by the substrate support 200 may be moved up and down by a substrate lifting unit 210.

The substrate lifting unit 210 may include a lifting pin 211 and a pin driving member 212. The lifting pin 211 is moved up and down while penetrating the substrate support 200 through a pin hole 200a of the substrate support 200, and the pin driving member 212 is connected to the lifting pin 211 to move the lifting pin 211 up and down. The lifting pin 211 moves the substrate S up while supporting the substrate S when being moved up by the pin driving member 212.

Furthermore, an individual exhaust duct 310 may be connected to the processing chamber 100 so that gases including fumes generated during the baking process are exhausted through the individual exhaust duct 310.

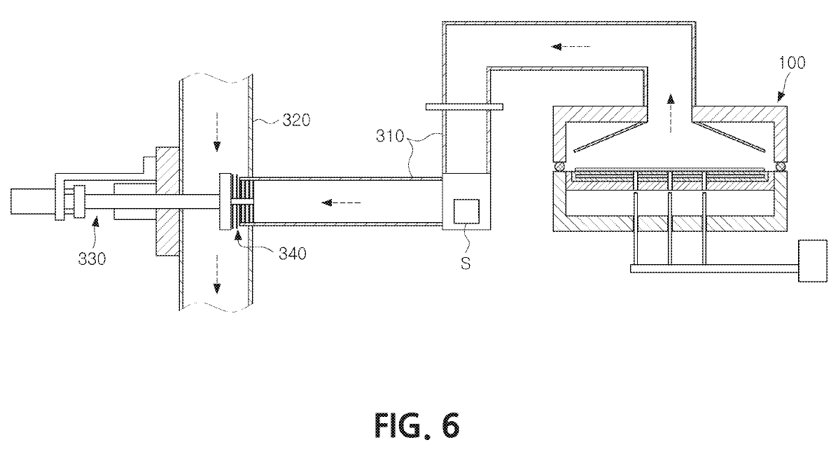

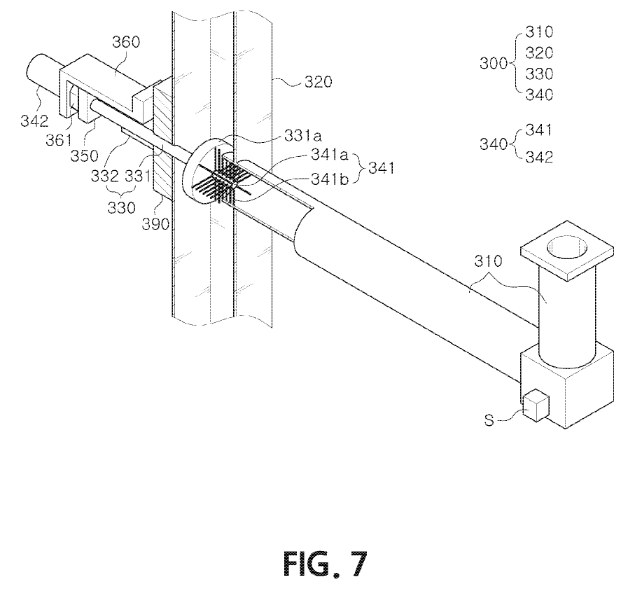

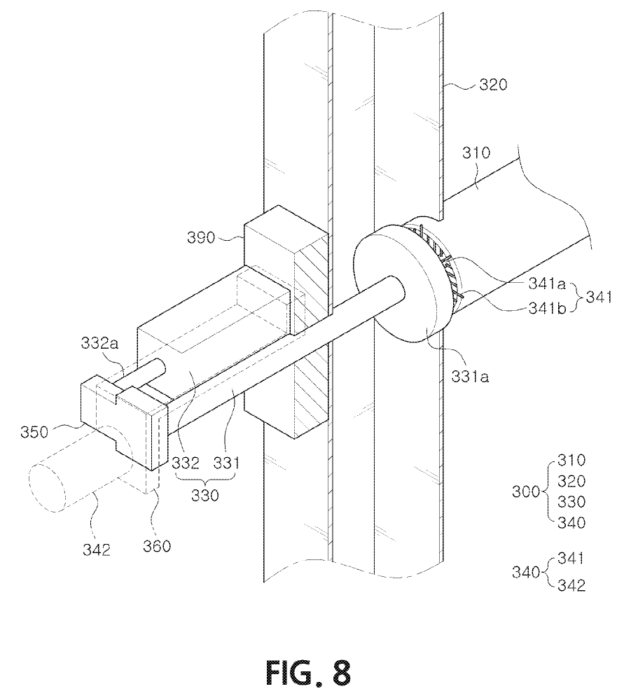

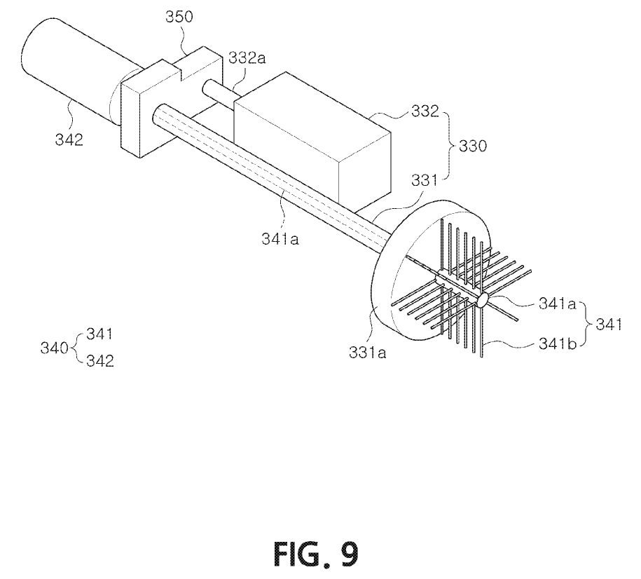

FIG. 6 is a view illustrating an exhaust structure connected to the processing chamber of FIGS. 5, 7 is a view illustrating the exhaust structure of FIGS. 6, 8 and 9 are views illustrating a damper and a brush of the exhaust structure of FIG. 7.

Referring to the drawings, the substrate treatment apparatus 1000 according to an example embodiment of the present disclosure may include an exhaust structure 300 connected to the processing chamber 100.

In a case where the processing chamber 100 is a bake chamber, the baking process can be performed in the substrate treatment space inside the processing chamber 100.

The above-described baking process may be performed after the photoresist is applied onto the substrate.

This baking process increases the density of the photoresist and enhances the adhesion of the photoresist to the wafer by heating the substrate to remove the organic solvent contained in the photoresist.

During the baking process, byproducts of the substrate treatment process are generated, and the byproduct may be fumes volatilized from the photoresist applied onto the substrate.

Such fumes may be exhausted through the exhaust structure 300 connected to the processing chamber 100.

The exhaust structure 300 may include an individual exhaust duct 310, a main exhaust duct 320, a damper 330, and a cleaner 340.

The individual exhaust duct 310 may be connected to the processing chamber 100 to exhaust gases inside the processing chamber 100. The gases include fumes, which are byproducts of the substrate treatment process.

Furthermore, a pressure sensor S capable of measuring an exhaust pressure may be installed in the individual exhaust duct 310.

In addition, the main exhaust duct 320 may be connected to an outlet of the individual exhaust duct 310, so that the fumes exhausted through the individual exhaust duct 310 are discharged through the main exhaust duct 320.

A plurality of individual exhaust ducts 310, which are connected to a plurality of processing chambers 100, may be connected to the main exhaust duct 320.

The damper 330 is configured to control the exhaust pressure of the individual exhaust duct 310.

That is, the damper 330 may be installed outside the individual exhaust duct 310 to limit the flow rate of gases coming out from the outlet of the individual exhaust duct 310, thereby controlling the exhaust pressure of the individual exhaust duct 310.

As an example, the damper 330 may be installed on the main exhaust duct 320 to which the outlet of the individual exhaust duct 310 is connected.

Meanwhile, the cleaner 340 is configured to clean at least one of the individual exhaust duct 310 and the damper 330.

To this end, the cleaner 340 is installed on the damper 330, and may extend toward the individual exhaust duct 310.

Specifically, the cleaner 340 may include a brush 341 and a driving motor 342.

The brush 341 is installed on the damper 330.

The brush 341 is configured to clean at least one of an inner surface of the outlet of the individual exhaust duct 310 and a distal end portion of the damper 330.

In addition, the driving motor 342 is configured to rotate the brush 341.

A speed reducer may be installed in the driving motor 342 to provide an appropriate rotational speed of the brush 341.

In addition, the brush 341 may be installed through the damper 330.

Specifically, the damper 330 includes a pressure regulating bar 331, and the brush 341 may be positioned through the pressure regulating bar 331.

The pressure regulating bar 331 is capable of reciprocating from the outside of the individual exhaust duct 310 toward the outlet of the individual exhaust duct 310, and has a pressure regulating plate 331a.

The pressure regulating plate 331a is formed at a distal end portion of the pressure regulating bar 331, and the pressure regulating plate 331a may be disposed to correspond to the outlet of the individual exhaust duct 310.

That is, the pressure regulating plate 331a may be disposed in parallel with the vertical cross section of the outlet, and may have a larger size than the vertical cross-section of the outlet.

The pressure regulating bar 331 moves from the outside of the individual exhaust duct 310 toward the outlet side of the individual exhaust duct 310, so that the pressure regulating plate 331a approaches the outlet when the pressure regulating bar 331 approaches the outlet, and moves away from the outlet of the individual exhaust duct 310, so that the pressure regulating plate 331a becomes away from the outlet.

The distance between the outlet of the individual exhaust duct 310 and the pressure regulating plate 331a may be set at an initial stage when the damper 330 is installed such that the exhaust pressure inside the processing chamber 100 becomes a predetermined appropriate exhaust pressure, and may then be maintained continuously during the substrate treatment process.

The brush 341 may include a rotation shaft 341a and a plurality of brush bristles 341b.

The rotation shaft 341a may be rotatably disposed through the pressure regulating bar 331, and may be connected to the driving motor 342.

That is, the pressure regulating bar 331 is formed to have a hollow through which the rotation shaft 341a is disposed, and the rotation shaft 341a is configured to be rotatable in the hollow of the pressure regulating bar 331. As an example, a bearing may be installed between the inner surface of the hollow and the rotation shaft 341a, or a lubricant may be filled between the inner surface of the hollow and the rotation shaft 341a.

In addition, the plurality of the brush bristles 341b may be formed at an end portion of the rotation shaft 341a.

That is, the driving motor 342 may be installed at one end portion of the rotation shaft 341a, and the plurality of brush bristles 341b may be installed at the other end of the rotation shaft 341a, the other end facing the outlet of the individual exhaust duct 310.

Specifically, the rotation shaft 341a may extend to the outside of the pressure regulating plate 331a.

That is, the rotation shaft 341a may extend to the outside of the pressure regulating plate 331a by penetrating the pressure regulating bar 331 and further penetrating the pressure regulating plate 331a.

The plurality of brush bristles 341b may extend into the interior of the individual exhaust duct 310.

The plurality of brush bristles 341b may be connected to an end portion of the rotation shaft 341a and arranged in a radial direction.

The plurality of brush bristles 341b may be configured to contact at least one of the inner surface of the outlet of the individual exhaust duct 310 and the distal end portion of the damper 330.

Specifically, the plurality of brush bristles 341b may be formed longer than the radius of the individual exhaust duct 310 so as to touch the inner surface of the individual exhaust duct 310.

Although the plurality of brush bristles 341b are illustrated in the drawings as having ends simply contacting the inner surface of the individual exhaust duct 310, the plurality of brush bristles 341b may actually be formed long enough to contact the inner surface of the individual exhaust duct 310 in a bent state.

Accordingly, when rotating by rotating the rotation shaft 341a, the plurality of brush bristles 341b may clean the inside of the individual exhaust duct 310.

That is, the fumes accumulated on or adhering to the inside of the individual exhaust duct 310 are swept away from the inner surface of the individual exhaust duct 310 by the plurality of brush bristles 341b when the plurality of brush bristles 341b rotates, thereby removing the fumes from the individual exhaust duct 310.

At an initial stage when the damper 330 is installed, the amount of exhaust through the individual exhaust duct 310 is adjusted and set. Thereafter, as the process continues, fumes may be accumulated in or adhere to the individual exhaust duct 310, which changes the exhaust pressure inside the processing chamber 100. These fumes are removed by the brush bristles 341b while rotating, so that the exhaust pressure in the processing chamber 100 can be constantly maintained at an appropriate exhaust pressure.

Some of the plurality of brush bristles 341b may be arranged in contact with the pressure regulating plate 331a so as to touch the pressure regulating plate 331a.

That is, some of the plurality of brush bristles 341b may be in contact with the pressure regulating plate 331a, not spaced apart from the pressure regulating plate 331a.

As a result, when rotating by rotating the rotation shaft 341a, the plurality of brush bristles 341b can clean the pressure regulating plate 331a.

That is, the fumes accumulated on or adhering to the pressure regulating plate 331a can be swept away from the pressure regulating plate 331a by the plurality of brush bristles 341b when the plurality of brush bristles 341b rotate, thereby removing the fumes from the damper 330.

At an initial stage when the damper 330 is installed, the amount of exhaust through the individual exhaust duct 310 is adjusted and set. Thereafter, as the process continues, fumes may be accumulated on or adhere to the pressure regulating plate 331a, which changes the exhaust pressure inside the processing chamber 100. These fumes are removed by the brush bristles 341b while rotating, so that the exhaust pressure in the processing chamber 100 can be constantly maintained at an appropriate exhaust pressure.

Meanwhile, the damper 330 may further include a driving cylinder 332.

The driving cylinder 332 may be installed outside the main exhaust duct 320.

As an example, the driving cylinder 332 may be connected to the main exhaust duct 320 by a fixing block 390.

The driving cylinder 332 is connected to the pressure regulating bar 331 to cause the pressure regulating bar 331 to reciprocate.

That is, the pressure regulating bar 331 of the damper 330 may automatically reciprocate toward the outlet of the individual exhaust duct 310 by the driving cylinder 332.

In order to set the exhaust pressure inside the processing chamber 100 to the predetermined appropriate exhaust pressure at an initial stage when the damper 330 is installed, the pressure regulating bar 331 may be moved by operating the driving cylinder 332 so as to automatically adjust the distance between the outlet of the individual exhaust duct 310 and the pressure regulating plate 331a.

Specifically, the pressure regulating bar 331 may be connected to a cylinder rod 332a of the driving cylinder 332 by a connecting bracket 350, and may extend toward the individual exhaust duct 310 inside the main exhaust duct 320 through one side portion of the main exhaust duct 320 from the outside of the main exhaust duct 320.

Here, the driving motor 342 may be installed outside the main exhaust duct 320, and may have a structure for rotating the rotation shaft 341a that extends toward the individual exhaust duct 310 through the pressure regulating bar 331.

The driving motor 342 may be installed on a fixing bracket 360 installed on an outer surface of the main exhaust duct 320.

Furthermore, the fixing bracket 360 may be connected to the main exhaust duct 320 by the fixing block 390 in order to minimize transfer of heat from the high-temperature main exhaust duct 320.

A protruding stopper 361 may be formed on the fixing bracket 360.

The protruding stopper 361 supports the connecting bracket 350 while preventing the connecting bracket 350 from moving in a direction away from the individual exhaust duct 310.

At an initial stage when the damper 330 is installed, the distance between the outlet of the individual exhaust duct 310 and the pressure regulating plate 331a is adjusted and set by the driving cylinder 332. The set state may be firmly maintained by the protruding stopper 361 supporting the connecting bracket 350 so that its movement is restricted.

Here, the degree in which the protruding stopper 361 protrudes varies among various fixing brackets 360. Therefore, a fixing bracket 360 including a protruding stopper 361 that protrudes in a degree corresponding to the distance between the outlet of the individual exhaust duct 310 and the pressure regulating plate 331a may be used.

While example embodiments have been shown and described above, it will be apparent to those skilled in the art that modifications and variations could be made without departing from the scope of the present invention as defined by the appended claims.

What is claimed is:

1. An exhaust structure for a substrate treatment apparatus, the exhaust structure comprising:
an individual exhaust duct connected to a processing chamber configured to treat a substrate;
a damper configured to adjust an exhaust pressure of the individual exhaust duct; and
a cleaner installed in the damper,
wherein the cleaner includes:
a brush installed in the damper, and configured to clean at least one of the inside of the individual exhaust duct and the damper; and
a driving motor configured to rotate the brush.

2. The exhaust structure according to claim 1, wherein the brush is installed through the damper.

3. The exhaust structure according to claim 2, wherein the damper includes:
a pressure regulating bar configured to reciprocate from the outside of the individual exhaust duct toward an outlet of the individual exhaust duct, the pressure regulating bar having a pressure regulating plate, and
the brush includes:
a rotation shaft rotatably disposed through the pressure regulating bar and connected to the driving motor; and
a plurality of brush bristles formed at an end portion of the rotation shaft.

4. The exhaust structure according to claim 3, wherein the rotation shaft extends to the outside of the pressure regulating plate, and
the plurality of brush bristles are connected to the end portion of the rotation shaft and arranged in a radial direction.

5. The exhaust structure according to claim 4, wherein the plurality of brush bristles are formed to have a length greater than a radius of the individual exhaust duct so as to touch an inner surface of the individual exhaust duct.

6. The exhaust structure according to claim 4, wherein some of the plurality of brush bristles are disposed in contact with the pressure regulating plate so as to touch the pressure regulating plate.

7. An exhaust structure for a substrate treatment apparatus, the exhaust structure comprising:
an individual exhaust duct connected to a processing chamber configured to treat a substrate;
a main exhaust duct connected to an outlet of the individual exhaust duct;
a damper installed in the main exhaust duct, and configured to adjust an exhaust pressure of the individual exhaust duct; and
a cleaner installed in the damper,
wherein the cleaner includes:
a brush installed in the damper, and configured to clean at least one of an inner surface of the outlet of the individual exhaust duct and a distal end portion of the damper; and
a driving motor configured to rotate the brush, and
the brush is installed through the damper, and has a plurality of brush bristles in contact with at least one of the inner surface of the outlet of the individual exhaust duct and the distal end portion of the damper.

8. The exhaust structure according to claim 7, wherein the damper includes:
a pressure regulating bar configured to reciprocate from the outside of the individual exhaust duct toward the outlet of the individual exhaust duct, the pressure regulating bar having a pressure regulating plate, and
the brush includes:
a rotation shaft rotatably disposed through the pressure regulating bar and connected to the driving motor; and
the plurality of brush bristles formed at an end portion of the rotation shaft.

9. The exhaust structure according to claim 8, wherein the rotation shaft extends to the outside of the pressure regulating plate, and
the plurality of brush bristles are connected to the end portion of the rotation shaft and arranged in a radial direction.

10. The exhaust structure according to claim 9, wherein the plurality of brush bristles are formed to have a length greater than a radius of the individual exhaust duct so as to touch an inner surface of the individual exhaust duct.

11. The exhaust structure according to claim 9, wherein some of the plurality of brush bristles are disposed in contact with the pressure regulating plate so as to touch the pressure regulating plate.

12. The exhaust structure according to claim 8, wherein the damper further includes:
a driving cylinder installed outside the main exhaust duct, and connected to the pressure regulating bar to cause the pressure regulating bar to reciprocate,
the pressure regulating bar is connected to a cylinder rod of the driving cylinder by a connecting bracket, and extends toward the individual exhaust duct inside the main exhaust duct through one side portion of the main exhaust duct from the outside of the main exhaust duct, and
the driving motor is installed outside the main exhaust duct, and is connected to the rotation shaft extending toward the individual exhaust duct through the pressure regulating bar.

13. The exhaust structure according to claim 12, wherein the driving motor is installed on a fixing bracket installed on an outer surface of the main exhaust duct, and
a protruding stopper is formed on the fixing bracket, the protruding stopper being configured to support the connecting bracket while preventing the connecting bracket from moving in a direction away from the individual exhaust duct.

14. A substrate treatment apparatus comprising:
a processing chamber having a substrate treatment space for treating a substrate;
a substrate support disposed inside the processing chamber, configured to support the substrate, and having a heater installed therein; and
an exhaust structure configured to exhaust gases including fumes inside the processing chamber,
wherein the exhaust structure includes:
an individual exhaust duct connected to the processing chamber;
a main exhaust duct connected to an outlet of the individual exhaust duct;
a damper installed in the main exhaust duct, and configured to adjust an exhaust pressure of the individual exhaust duct; and
a cleaner installed in the damper,
the cleaner includes:
a brush installed in the damper, and configured to clean at least one of an inner surface of the outlet of the individual exhaust duct and a distal end portion of the damper; and
a driving motor configured to rotate the brush, and
the brush is installed through the damper, and has a plurality of brush bristles in contact with at least one of the inner surface of the outlet of the individual exhaust duct and the distal end portion of the damper.

15. The substrate treatment apparatus according to claim 14, wherein the damper includes:
a pressure regulating bar configured to reciprocate from the outside of the individual exhaust duct toward the outlet of the individual exhaust duct, the pressure regulating bar having a pressure regulating plate, and
the brush includes:
a rotation shaft rotatably disposed through the pressure regulating bar and connected to the driving motor; and
the plurality of brush bristles formed at an end portion of the rotation shaft.

16. The substrate treatment apparatus according to claim 15, wherein the rotation shaft extends to the outside of the pressure regulating plate, and
the plurality of brush bristles are connected to the end portion of the rotation shaft and arranged in a radial direction.

17. The substrate treatment apparatus according to claim 16, wherein the plurality of brush bristles are formed to have a length greater than a radius of the individual exhaust duct so as to touch an inner surface of the individual exhaust duct.

18. The substrate treatment apparatus according to claim 16, wherein some of the plurality of brush bristles are disposed in contact with the pressure regulating plate so as to touch the pressure regulating plate.

19. The substrate treatment apparatus according to claim 15, wherein the damper further includes:
a driving cylinder installed outside the main exhaust duct, and connected to the pressure regulating bar to cause the pressure regulating bar to reciprocate,
the pressure regulating bar is connected to a cylinder rod of the driving cylinder by a connecting bracket, and extends toward the individual exhaust duct inside the main exhaust duct through one side portion of the main exhaust duct from the outside of the main exhaust duct, and,
the driving motor is installed outside the main exhaust duct, and is connected to the rotation shaft extending toward the individual exhaust duct through the pressure regulating bar.

20. The substrate treatment apparatus according to claim 19, wherein the driving motor is installed on a fixing bracket installed on an outer surface of the main exhaust duct, and
a protruding stopper is formed on the fixing bracket, the protruding stopper being configured to support the connecting bracket while preventing the connecting bracket from moving in a direction away from the individual exhaust duct.
